(19) United States
(12) Patent Application Publication
(10) Pub. No.: US 2021/0264810 A1
(43) Pub. Date: Aug. 26, 2021

(54) METHOD AND SYSTEM FOR GENERATING A VIRTUAL REALITY TRAINING SESSION

(71) Applicants: Rebecca Johnson, München (DE); Timothy Kamleiter, Nürnberg (DE); Asa MacWilliams, Fürstenfeldbruck (DE); Georg Schöler, Erlangen (DE); Robert Wilde, München (DE)

(72) Inventors: Rebecca Johnson, München (DE); Timothy Kamleiter, Nürnberg (DE); Asa MacWilliams, Fürstenfeldbruck (DE); Georg Schöler, Erlangen (DE); Robert Wilde, München (DE)

(21) Appl. No.: 17/255,280

(22) PCT Filed: Jun. 24, 2019
(86) PCT No.: PCT/EP2019/066642

§ 371 Date: Dec. 22, 2020

(30) Foreign Application Priority Data
Jun. 26, 2018 (EP) 18179801.8

(51) Int. Cl. G09B 19/00; G09B 9/00; G09B 19/24

(52) U.S. Cl. CPC G09B 19/003; G09B 19/24; G09B 9/00

(57) ABSTRACT

Systems and methods for generating a virtual reality training session for a procedure to be performed by at least one trainee on a virtual reality (VR) model of a physical object of interest in a technical environment. The method includes the steps of: loading the virtual reality (VR) model of the object of interest from a database into a virtual reality (VR) authoring system; specifying atomic procedural steps of the respective procedure by a technical expert and performing the specified atomic procedural steps in a virtual environment provided by the virtual reality (VR) authoring system by the technical expert on the loaded virtual reality (VR) model of the object of interest; and recording the atomic procedural steps performed by the technical expert in the virtual environment and linking the recorded atomic procedural steps to generate automatically the virtual reality training session stored in the database and available for the trainees.

### CROSS REFERENCE TO RELATED APPLICATIONS

This present patent document is a §371 nationalization of PCT Application Serial Number PCT/EP2019/066642 filed Jun. 24, 2019, designating the United States, which is hereby incorporated in its entirety by reference. This patent document also claims the benefit of EP 18179801.1 filed on Jun. 26, 2018 which is also hereby incorporated in its entirety by reference.

### FIELD

Embodiments relate to a method and a virtual reality authoring system for generating a virtual reality (VR) training session for a procedure to be performed by at least one trainee on a virtual reality model of a physical object of interest.

### BACKGROUND

In many applications users have to perform procedural steps in a procedure to be performed in a technical domain. For example, field service technicians have to maintain and/or repair a specific machine within a manufacturing facility. Another example is a medical expert having expertise how to perform a specific operation during surgery and wishes to share this knowledge with colleagues. Another doctor in a similar situation faced with surgical operation needs information how to proceed from another expert.

Sharing of procedural knowledge is conventionally done within teaching sessions where a domain expert demonstrates the procedure to a trainee or group of trainees. The domain expert may use instruction manuals or instruction videos.

The conventional approach of training trainees for technical procedures includes several drawbacks. The domain expert having expert knowledge or expertise concerning the respective technical procedure may only teach or train a limited number of trainees at a time. Further, domain expert has to invest resources, for example time for training other persons requiring training. Further, some domain experts may find it difficult to explain technical details to trainees because they are deemed to be trivial or self-evident to the domain expert, thus making it difficult to train the trainees efficiently. Moreover, there may be language barriers between the training domain expert and the trained novices having less experience in the technical field.

### BRIEF SUMMARY AND DESCRIPTION

The scope of the present invention is defined solely by the appended claims and is not affected to any degree by the statements within this summary. The present embodiments may obviate one or more of the drawbacks or limitations in the related art.

Embodiments provide a method and a system that increases the efficiency of sharing procedural knowledge between domain experts of a technical domain and trainees.

Embodiments provide a method for generating a virtual reality (VR) training session for a procedure to be performed by at least one trainee on a virtual reality (VR) model of a physical object of interest in a technical environment, the method including: loading the virtual reality (VR) model of the object of interest from a database into a virtual reality (VR) authoring system; specifying atomic procedural steps of the respective procedure by a technical expert, E, and performing the specified atomic procedural steps in a virtual environment provided by the virtual reality (VR) authoring system by the technical expert, E, on the loaded virtual reality (VR) model of the object of interest; and recording the atomic procedural steps performed by the technical expert, E, in the virtual environment and linking the recorded atomic procedural steps to generate automatically the virtual reality (VR) training session stored in the database and available for the trainees, T. Each recorded atomic procedural step performed by the technical expert, E, in the three-dimensional virtual environment is enriched with supplementary data selected by the technical expert, E, in the three-dimensional virtual environment provided by the virtual reality (VR) authoring system. The supplementary data includes photographs, instruction videos, audio recordings, sketches, slides, text documents and/or instruction manuals.

In an embodiment, the supplementary data is imported by the virtual reality (VR) authoring system from different data sources and/or databases and linked to the recorded atomic procedural step.

In an embodiment, the technical expert, E, performs one or more atomic procedural steps in the three-dimensional virtual environment provided by the virtual reality (VR) authoring system using virtual tools loaded from a database into the virtual reality (VR) authoring system and selected by the technical expert, E, in the three-dimensional virtual environment for performing the respective atomic procedural steps.

In an embodiment, each recorded atomic procedural step of a procedure is linked to at least one previously recorded procedural step of the same procedure by the technical expert, E, in the virtual environment or linked depending on the supplementary data selected by the technical expert, E, for the recorded atomic procedural step.

In an embodiment, the generated virtual reality (VR) training session stored in the database of the virtual reality (VR) authoring system is made available in a training operation mode to a virtual reality (VR) device of the trainee that displays the atomic procedural steps of the training session to the respective trainee emulating the displayed atomic procedural steps of the training session in the three-dimensional virtual environment provided by the virtual reality (VR) device of the trainee, T.

In an embodiment, in an examination operation mode, the atomic procedural steps performed by the trainee in the three-dimensional virtual environment provided by its virtual reality (VR) device are recorded and compared automatically with the recorded atomic procedural steps performed by the domain expert, E, in the three-dimensional virtual environment of the virtual reality (VR) authoring system to generate comparison results and a feedback to the trainee indicating whether the trainee has performed the respective atomic procedural steps correctly or not.

In an embodiment, the comparison results are stored and evaluated to analyze a training progress of the trainee, T.

In an embodiment, the generated virtual reality (VR) training session stored in the database of the virtual reality (VR) authoring system is made available to an augmented reality, AR, guiding device of a qualified trainee that displays the virtual reality (VR) training session to the trainee who emulates the displayed atomic procedural steps in the technical environment to perform the procedure on the physical object of interest.

In an embodiment, the virtual reality (VR) model of the object of interest is derived automatically from an available computer-aided design, CAD, model of the physical object of interest or from a scan of the physical object of interest.

In an embodiment, the virtual reality (VR) model of the object of interest is a hierarchical data model representing the hierarchical structure of the physical object of interest including of a plurality of components.

In an embodiment, virtual tools used by the technical expert, E, or trainee in the three-dimensional virtual environment to perform atomic procedural steps are derived automatically from available computer-aided design, CAD, models of the respective tools.

In an embodiment, the atomic procedural step performed by the technical expert, E, or the trainee in the three-dimensional virtual environment includes a manipulation of at least one displayed virtual component of the object of interest with or without use of a virtual tool, for example moving the displayed virtual component, removing the displayed virtual component, replacing the displayed virtual component by another virtual component, connecting a virtual component to the displayed virtual component and/or changing the displayed virtual component.

Embodiments further provide a virtual reality (VR) authoring system for generating a virtual reality (VR) training session for a procedure to be performed by at least one trainee on a virtual reality (VR) model of a physical object of interest.

Embodiments further provide a virtual reality (VR) authoring system for generating a virtual reality (VR) training session for a procedure to be performed by at least one trainee on a virtual reality (VR) model of a physical object of interest, the authoring system including a processing unit configured to perform any of the possible embodiments of the method.

### BRIEF DESCRIPTION OF THE FIGURES

In the following, possible embodiments are described in more detail with reference to the enclosed figures.

FIG. 1 depicts a block diagram for illustrating a system for sharing automatically procedural knowledge.

FIG. 2 depicts a flow chart of a method for sharing automatically procedural knowledge.

FIG. 3 depicts an exemplary data structure of a data set as used by the system shown in FIG. 1 and the method shown in FIG. 2.

FIG. 4 depicts schematically an illustration of a training and/or guiding sequence that may be generated by the method shown in FIG. 2 and the system shown in FIG. 1.

FIG. 5 depicts a possible operation of a method shown in FIG. 2 and the system shown in FIG. 1.

FIG. 6 depicts a possible operation of the system shown in FIG. 1 and method shown in FIG. 2 using an embodiment of a virtual reality training authoring system. FIG. 7 depicts a flowchart of an embodiment of a method for generating a virtual reality (VR) training session.

### DETAILED DESCRIPTION

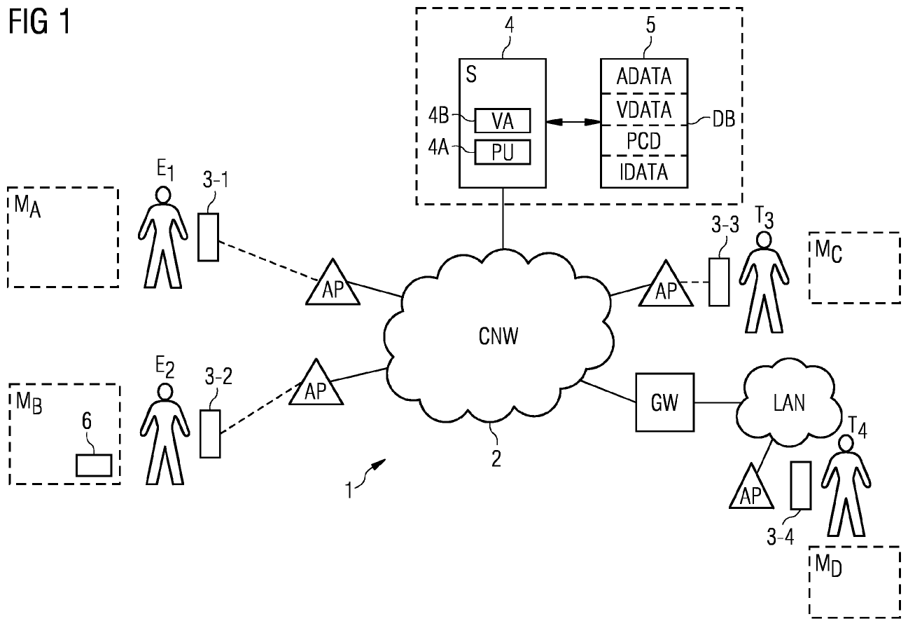

FIG. 1 depicts schematically a system 1 for sharing automatically procedural knowledge between domain experts E of a technical domain and trainees T. The system 1 includes a communication network 2 used for communication between computing devices 3-1, 3-2, 3-3, 3-4 of domain experts E and trainees T. The number of domain experts E and associated portable computing devices 3-i as well as the number of trainees T wearing portable computing devices 3-i may vary depending on the use case. The different portable computing devices 3-i may be connected via wireless links to access points AP of the communication network 2 or indirectly via an access point of the local area network and a gateway GW as also depicted in FIG. 1. The system or platform for sharing automatically procedural knowledge between different domain experts E and trainees T may include at least one central server 4 connected to the communication network 2. The server 4 has access to a central database 5 forming a data storage for audio data, video data, procedure context data, PCD as well as instruction data (I data). The different experts E1, E2 as depicted in FIG. 1 have expertise knowledge concerning the procedure to be performed in a technical domain. This procedure may be for instance a repair procedure or a maintenance procedure of a machine M serviced by the respective expert E. As depicted in FIG. 1, the machines Mₐ and M_{b} undergo a procedure by a technical expert E performing, for example procedural steps of a maintenance or repair procedure. The computing devices 3-1, 3-2 of the domain experts E1, E2 are configured to provide the server 4 of the platform or system 1 with observations of the domain experts E1, E2 while performing the procedure in the technical domain. The observations received by the server 4 are evaluated by a processing unit 4A of the server 4 to generate automatically instructions for the trainees T. The generated instructions may be supplied to the computing devices 3-3, 3-4 worn by the trainees T while performing the respective procedure at other machines M_{c}, M_{d} as depicted in FIG. 1. The server includes a processing unit 4A configured to process the received observations to generate automatically instructions for the trainees T. Besides the processing unit 4A, the server 4 includes a virtual assistant 4B configured to interact with the domain experts E1, E2 and/or with the trainees T3, T4 while performing the respective procedure in the technical domain to trigger or provoke observations, actions and/or comments of the respective domain expert E and/or trainee T. The virtual assistant 4B of the server 4 may include an autonomous agent configured to perform autonomously dialogues with the domain experts E and/or trainees T while performing the procedure in the technical domain to trigger actions and/or to get comments of the respective domain experts E and/or trainees T recorded by the computing devices 3 and supplied to the server 4 via the communication network 2 of the system 1. Procedure context data PCD of a procedure performed by a domain expert E or a trainee T is retrieved automatically by the associated computing device 3 worn by the respective domain expert E or trainee T and supplied to the server 4 via the communication network 2. The procedural context data PCD of a procedure retrieved by a computing device 3 may include machine data of a machine M serviced by the respective domain expert E or trainee T in the procedure. Actions and/or comments of a domain expert E or a trainee T recorded by its computing device 3-i during the procedure may include audio data and/or video data. The audio data and video data may be evaluated automatically by the processing unit 4A along with the procedure context data PCD of the procedure to provide or create a dialogue with the respective domain expert E and/or trainee T. Further, the audio data and/or video data may be evaluated automatically by the processing unit 4A with the procedure context data PCD of the procedure to provide a feedback for the respective domain expert E and/or trainee T via its computing device 3-i.

As depicted in FIG. 1, the server 4 includes access to a database 5 configured to store audio data and/or video data recorded for a plurality of domain experts E or trainees T along with the associated procedure context data PCD. The actions and/or comments recorded by the computing device 3 of a domain expert E or a trainee T in a selected operation mode of its computing device 3 while performing procedural steps of the procedure are tagged with labels L associated with the respective procedure steps and/or selected operation mode. The labels L associated with the respective procedure steps of a procedure may be generated by the processing unit 4A automatically on the basis of specific actions and/or comments of the domain expert E or trainee T while performing the procedure in the technical domain and/or on the basis of the procedure context data PCD of the respective procedure.

The processing unit 4A of the server 4 may include a processor configured to extract relevant audio data and/or video data of procedure steps stored in the database 5 on the basis of the associated labels and/or on the basis of the procedure context data to generate a training sequence or a guiding sequence for a procedure to be performed by a trainee T including the extracted audio data and/or extracted video data. The extraction of the relevant audio data and/or video data may be performed by an artificial intelligence module implemented in the processing unit 4A. The training sequence or guiding sequence may be enriched by the processing unit 4A with instructional data loaded from the database 5 of the system for the respective procedure context. Instructional data may include for instance data collected from different data sources including, for example documentation data from machine data models of a machine M or machine components, scanned data and/or recorded audio and/or video data of training and/or guiding sequences previously executed by a domain expert or trainee. Each computing device may be operated in different operation modes OM. The selectable operation modes may include for example a teaching operation mode, T-OM, where observations provided by the computing device 3 are tagged as expert observations and a learning operation mode, L-OM, where observations provided by the computing device 3 are tagged automatically as trainee observations.

The computing devices 3-i carried by the experts E and/or trainees T are portable computing devices that may be carried by the expert or trainee or that are attached to the expert or trainee. The wearable computing devices 3-i may include one or more cameras worn by the user at his head, chest, or arms. Wearable computing devices 3 further may include a user interface including one or more microphones arranged to record the user's voice. Further, the user interface of the wearable computing device 3 may include one or more loudspeakers or headphones. Further, each wearable computing device 3-i includes a communication unit that allows to set up a communication with the server 4 of the platform 1. Each wearable computing device 3 includes at least one processor with appropriate application software. The processor of the computing device 3 is connected to the user interface UI of the wearable computing device 3 to receive sensor data, for example video data from the cameras and/or audio data from the microphones. The computing unit or processor of the wearable computing device 3 is configured to provide observations of the user while performing the procedure in the technical domain and to transmit the observations via the communication interface of the computing device 3 and the communication network 2 to the server 4 of the platform. The computing unit of the device 3-i is configured to preprocess data received from the cameras and/or microphones to detect relevant actions and/or comments of the user. The actions may include for instance the picking up of a specific tool by the expert E or trainee T during the procedure in the technical domain such as a repair or maintenance procedure. The detection of a relevant action may be performed by processing audio comments of the user, for example the expert E or a trainee T or by detection of specific gestures on the basis of processed video data.

The software agent 4B of the server 4 is configured to interact with users and may include, for example a chatbot providing a voice-based interface to the users. The virtual assistant VA including the chatbot may for instance be configured to interact with the domain expert E and/or trainee T while performing the procedure in the technical field. The virtual assistant VA may include a chatbot to perform autonomously a dialogue with the respective user. The dialogue performed between the chatbot and the user may be aligned with actions and/or comments made by the user. For instance, if video data provided by the computing device 3 of the user show that the user picks up a specific tool to perform a procedural step during the maintenance or repair procedure, the chatbot of the virtual assistant VA may generate a question concerning the current action of the user. For instance, the chatbot of the virtual assistant VA may ask a technical expert E a specific question concerning his current action such as “what is the tool you just picked up?”. The comment made by the expert E in response to the question may be recorded by the computing device 3 of the expert E and transmitted to the server 4 of the system to be memorized in the database 5 as audio data of a procedural step of the repair or maintenance procedure performed by the expert E. After the expert E has picked up the tool and has answered the question of the chatbot the expert E may start to perform maintenance or repair of the machine. The computing device 3 of the expert E records automatically a video of what the expert is doing along with potential comments made by the expert E during the repair or maintenance action performed with the picked-up tool. The actions and/or comments of the domain expert E recorded by its computing device 3, during the procedure may include audio data including the expert's comments and/or video data showing the expert's actions that may be evaluated by an autonomous agent of the virtual assistant VA to provide or generate dialogue elements output to the expert E to continue with the interactive dialogue. In parallel, procedure context of the procedure performed by the expert E may be retrieved by the computing device 3 worn by the expert and supplied to the server 4 via the communication network 2. The context data may include for instance machine data read from a local memory of the machine M that is maintained or repaired by the expert E. In the example depicted in FIG. 1, the machine Mb that is serviced by the domain expert E2 includes a local memory 6 storing machine data of the machine Mb that may be retrieved by the computing device 3-2 of the expert and forwarded to the server 4 of the platform. The context data of the process may for instance indicate a machine type for identification of the machine Mb that may be stored in the database as procedure context data PCD. The server 4 may store audio data and/or video data recorded for a procedural step of a procedure along with associated procedure context data PCD in the database 5. The audio data and/or video data may be tagged with labels L associated with the respective procedural step. The labels may be generated automatically by the processing unit 4A on the basis of specific actions and/or comments of the user while performing the procedure in the technical domain. Comments made by the user during the procedure may be processed to detect key words that may be used as procedure context data PCD for the respective procedure. The labels and/or tags of audio data and/or video data generated as observations by the computing device 3 of the respective user may be stored as procedure context data PCD for the respective audio data and/or video data along with the audio data and/or video data in the database 5 of the system. The tagging and/or labelling may be performed automatically, for instance on the basis of machine data read from a local memory of the machine M. The tagging may be made by the expert E or user during the procedure by specific comments spoken into a microphone of the user interface UI of the computing device 3 including for instance key words for labelling the audio and/or video data provided by the sensors of the computing device of the user. The wearable computing devices 3 of the trainees T may include an additional display unit worn on the trainee's head to provide the trainee T with a guiding or training sequence regarding the handling of the respective machine.

The chatbot of the virtual assistant VA may also perform a dialogue with the trainee T, for instance to receive questions of the trainee during the procedure such as “which of these tools do I need now?”. The virtual assistant VA may play back previously recorded videos of experts E showing what they are doing in a particular situation during a maintenance and/or repair procedure. The virtual assistant VA may further allow the trainee T to provide a feedback to the system how useful a given instruction has been for his purpose.

The database 5 of the platform is configured to index or tag procedure steps for individual video and/or audio data sequences. The processing unit 4A may include an artificial intelligence module AIM that is configured to extract relevant pieces of recorded video and/or audio sequences and to index them according to the comments made by the expert E in a specific situation of the procedure as well as on the basis of the data that are included in the video sequences or audio sequences. The artificial intelligence module AIM may be configured to query the database 5 for appropriate video data when a trainee T requires them during a procedure. The server 4 may also send communication messages such as emails to the users and may send also rewards to experts E who have shared useful knowledge with trainees T.

FIG. 5 depicts schematically an example illustrating the interaction of the system with users. In the depicted example, two experts “Jane” (E1) and “Jack” (E2) are connected by the portable computing devices 3 with the system 1 for sharing automatically procedural knowledge with a trainee “Joe” (T).

A possible dialogue between the experts E and the trainee T may be as follows. First, the first expert “Jane” (E1) is working in a procedure, for instance in a repair or maintenance procedure at a machine Mₐ. During the operation, the actions and/or comments of the domain expert “Jane” (E1) are monitored by its computing device 3-1 to detect interesting actions and/or comments during the procedure. The computing device 3 includes an integrated virtual assistant VA configured to interact with the user by performing the procedure that may in a possible implementation also be supported by the virtual assistant VA integrated in a module 4B of the server 4. If the computing device 3 detects that the first expert “Jane” (E1) is performing something interesting the chatbot of the virtual assistant VA may ask the first expert “Jane” (E1) a question.

Computing device 3 of “Jane” (E1): “Excuse me, Jane, what is that tool you've been using?”

Reply of expert “Jane” (E1): “Oh, that's a screwdriver I need to fix the upper left screw of the housing.”

The chatbot may then ask via the computing device 3 of the expert “Jane”: “Ah, how do you fix the screw in the housing?” that triggers the reply of the technical expert “Jane”: “See, like this, right here” while the domain expert performs the action of fixing the screw in the housing of the machine recorded by the camera of its computing device 3. The dialogue may be finalized by the chatbot of the virtual assistant VA as follows “Thank you!”

Later if the second expert “Jack” (E2) is taking a similar machine M apart, the processing unit may continuously evaluate video and/or audio data provided by the computing device to detect procedural steps performed by the expert. In the example, an artificial intelligence module AIM of the processing unit 4A may have learned from the previous recording of the other expert “Jane” (E1) that the video data depicts a specific component or element, for example the screw previously assembled in the housing of the machine M by the first expert “Jane”. After having made this observation the chatbot of the virtual assistant VA may ask the second expert “Jack” (E2) a question as follows: “Excuse me, Jack, is that a screw that you want to use to assemble the housing?” This may trigger the following reply of the second expert “Jack”: “Yes, indeed it is . . . ” The chatbot of the virtual assistant VA may then end the dialogue by thanking the second expert “Jack”: “Thank you!”

Later, the trainee T may have the task to fix the housing by assembling the screw and has no knowledge or expertise to proceed as required. The trainee T may ask via its computing device 3 the platform for advice in the following dialogue. The trainee “Joe” may ask: “Ok, artificial intelligence module, please tell me what is this screw that I am supposed to use to fix the housing?” The computing device 3 of the trainee “Joe” may output for example: “It's this thing over here . . . ”

The same moment the platform depicts the trainee “Joe” by the display of his computing device 3 an image or video recorded previously by the computing device 3 of the second expert “Jack” (E2) with the respective component, for example the screw, highlighted. The trainee “Joe” may then ask via its computing device 3 the system the follow-up question: “Ok, and how do I fix it?” The reply output by the user interface UI of the computing device 3 of the trainee T may be: “You may use a screwdriver as shown . . . ”, wherein the display of the trainee “Joe” outputs the video sequence that has been recorded by the computing device 3 of the first expert “Jane”. The trainee T may end the dialogue, for instance by the following comment: “Thanks, that helped!”

Finally, both experts “Jack” and “Jane” may receive thanks from the system via an application on the portable computing devices 3. For instance, the portable computing device 3 of the first expert “Jane” (E1) may display the following message; “Thanks from Joe for your help in assembling housing of the machine using a screwdriver!” Also, on the computing device 3 of the other expert “Jack” (E2) a thank you-message may be output as follows: “Thanks from Joe on identifying the screw!”

The system may take advantage of an interaction format of chatbot to ask experts E in the technical domain questions. The chatbot of the virtual assistant VA implemented on the portable computing device 3 and/or on the server 4 of the platform may put the expert E into a talkative mood so that the expert E is willing to share expert knowledge. Similarly, the chatbot implemented on the computing device a3 of a trainee T or on the server 4 of the platform, will reduce the trainee's inhibition to ask questions so that the trainee T is more willing to ask for advice. The system 1 may record and play videos on the wearable computing devices 3 so that the trainee T may see video instructions from the same perspective as during the actual procedure. The system 1 may further use audio tracks from recorded videos evaluated or processed to extract index certain elements in the video sequence. Further, the system may provide experts E with rewards for sharing the expert knowledge with trainees T. The system 1 does not require any efforts to explicitly offer instructions. The experts E may share the knowledge when asked by the chatbot without slowing down the work process during the procedure. Accordingly, the observations of the domain experts E may be made during a routine normal procedure of the expert E in the respective technical domain. Accordingly, in the normal routine the expert E may provide knowledge to the system 1 when asked by the chatbot of the virtual assistant VA.

In contrast to conventional platforms, where an expert E explicitly teaches trainees T who may stand watching the system may scale indefinitely. While a trainer may only teach two or more trainees at a time, the content recorded and shared by the system 1 may be distributed to an unlimited number of distributed trainees T.

The system 1 may also use contextual data of machines or target devices. For example, the computing device 3 of an expert E may retrieve machine identification data from a local memory of the machine M that the expert E is servicing including, for instance a type of the machine. This information may be stored along with the recorded audio and/or video data in the database 5. Similarly, the computing device 3 of a trainee T may query the machine M that the trainee T is servicing and an artificial intelligence module AIM of the processing unit 4A may then search for video and/or audio data of similar machines.

Additional instructional material or data is stored in the database 5, for instance part diagrams or animated 3D data models. For example, the computing device 3 of the trainee T may show a three-dimensional diagram of the machine M being serviced by the trainee T. This three-dimensional diagram may be stored in the database 5 of the system 1 and the trainee T may query for it explicitly so that for example, the artificial intelligence module AIM will suggest it to the trainee T as follows: “may I show you a model of the machine component?” There are several possible mechanisms for providing additional data, for example additional instructional data that may be linked to the recorded video and/or audio data without explicit annotation. For example, if an expert E looks at a particular three-dimensional data model on his portable computing device 3 when performing a procedure or task, this may be recorded by his portable computing device 3. The same model may then be shown to the trainee T when performing the same task. Further, if each data model includes a title, a trainee may search for an appropriate data model by voice commands input in the user interface UI of his computing device 3.

The artificial intelligence module AIM implemented in the processing unit 4A of the server 4, may include a neural network NN and/or a knowledge graph.

The computing device 3 of a trainee T may also be configured to highlight particular machine parts in an augmented reality, AR, view on the display of the computing device 3 of the trainee. The computing device 3 of the trainee T may include a camera similar to the computing device of an expert E. The computing device 3 of the expert E may detect items in the trainee's current view that also appear in a recorded video of the expert E and the computing device 3 of the trainee T may then highlight them if they are relevant.

The computing devices 3 of the trainee T and expert E may be identical in terms of hardware and/or software. They include both cameras and display units. Accordingly, colleagues may use the computing devices to share knowledge symmetrically, for example a trainee T in one technical area may be an expert E in another technical area and vice versa.

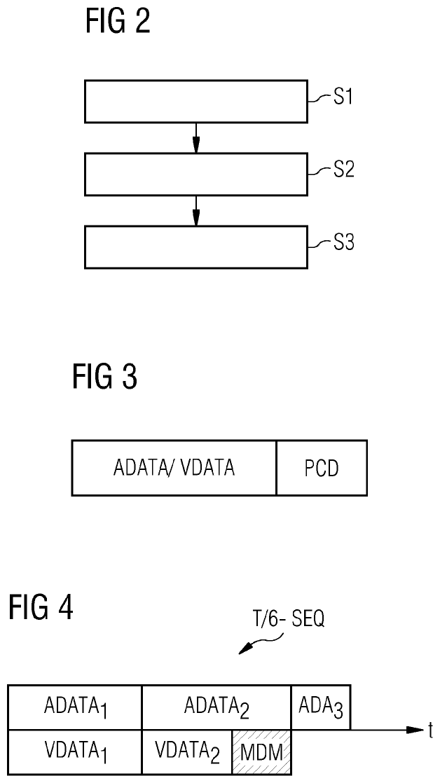

FIG. 2 depicts a flowchart of a method for sharing automatically procedural knowledge between domain experts E and trainees T. The method depicted in FIG. 2 may be performed using a platform as depicted in FIG. 1.

In a first step S1, the server receives observations made by computing devices of domain experts E by performing a procedure in the technical domain.

In a further step S2, the received observations are processed by the server to generate automatically instructions for trainees T.

In a further step S3, computing devices worn by trainees T while performing the respective procedure in the technical domain are provided by the server with the generated instructions.

FIG. 3 illustrates schematically a possible data structure that may be used by the method and system shown in FIGS. 1 and 2. Recorded audio data and/or video data will be stored along with procedure context data PCD in the database 5 of the platform. The procedure context data PCD may include for instance machine data of the machine M serviced by the respective domain expert E and/or trainee T during a maintenance or repair procedure. Further, the procedure context data PCD may include labels L generated during the recording of the audio data and/or video data. The procedure context data PCD may for instance include labels L associated with respective procedure steps and/or selected operation modes OM. Each computing device 3-i of the platform may be operated in one group of selectable operation modes. The operation modes OM may include in a possible implementation a teaching operation mode T-OM. Observations provided by the computing device 3 are tagged automatically as expert observations. Further, the operation mode may include a learning operation mode L-OM, where observations provided by the computing device 3 are tagged automatically as trainee observations. The tags or labels may be stored as procedure context data PCD along with the recorded audio data and/or video data. The labels L stored as procedure context data PCD may also be generated in response to comments made by a user during the procedure. Further, the procedure context data PCD may be generated automatically by actions recorded as video data during the procedure, for example specific gestures made by the user. The procedure context data PCD may include a plurality of further information data generated automatically during the procedure, for instance time stamps indicating when the audio data and/or video data have been recorded, location data indicating the location where the audio data and/or video data have been recorded, as well as user profile data providing information about the user having performed the procedural step within a procedure including information about the level of knowledge of the respective user, for example whether the user is regarded as an expert E or a trainee T for the respective procedure. Other possible procedure context data PCD may include information about the language spoken by the respective user.

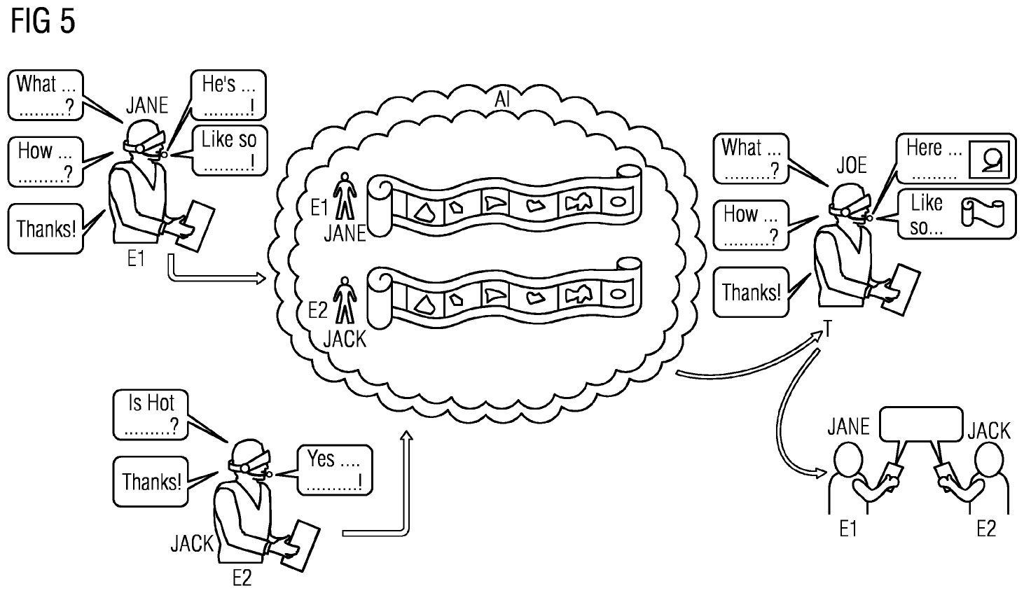

FIG. 4 illustrates a training and/or guiding sequence output by the platform using data stored in the database 5 of the platform. The processing unit 4A of the server 4 may be configured to extract relevant audio data and/or video data of procedure steps stored in the database 5 on the basis of associated procedure context data PCD to generate or assemble a training and/or guiding sequence for a trainee T including the extracted audio data and/or extracted video data. Recorded audio data and/or recorded video data stored in the database 5 may be output via the computing device 3 of a trainee T according to a dialogue performed between the trainee T and the chatbot of the virtual assistant VA implemented in the computing device 3-i of the trainee T or on the server 4 of the platform. The recorded audio data and video data may be output simultaneously in parallel as different information channels via the display unit of the portable computing device 3 of the trainee T and via the headphones of the user interface of the computing device 3 of the trainee T. In the depicted example of FIG. 4, first audio data ADATA1 recorded from a first expert E1 may be displayed to the trainee T along with video data showing the actions of this expert E1. The next procedural step within the procedure may be explained to the trainee T by further audio data ADATA2 recorded from a second expert E2 along with video data showing the actions of this other expert E2 as VDATA2. In the depicted example, the length of the video data stream VDATA2 is shorter than the audio data ADATA2 of the expert E2 and is followed by instruction data, for example a machine data model MDM of the respective machine component handled by the second expert E2 during this procedure step. The training sequence or guiding sequence depicted in FIG. 4 may be followed by acoustic data ADATA3 of a third expert E3 explaining a further procedural step without available video data. As may be seen, the training sequence or guiding sequence includes series of audio data sets and/or video data sets concatenated or linked using procedure context data PCD. The training sequence or guiding sequence for a procedure to be performed by a trainee T includes extracted audio data and/or extracted video data stored in the database 5 of the platform. The training or guiding sequence may be enriched by the processing unit 4A with instructional data loaded from the database 5 of the system for the respective procedure context data PCD. The instructional data used to enrich the training and/or guiding sequence may include data collected from different data sources including documentation data, machine data models, scanned data, recorded audio and/or video data of training and/or guiding sequences previously executed by a domain expert or trainee. The collected data may include data provided by different data sources including CAD models of machines M to be maintained, photographs or videos of real maintenance procedures and/or three-dimensional scans of special tools or parts. The CAD models of machines to be maintained include typically construction models, not necessarily configured for training. The CAD models may be simplified and converted into a format appropriate for training, for example by removing small parts or components from the model that are not visually relevant for the training process. This may be accomplished by an automatic model conversion and simplification process performed by the processing unit 4A of the server 4.

The data sources may also provide photographs or videos of real maintenance procedures. These may be available from previous live training sessions. Additional, non-VR documentation may be used such as sketches or slides. The documents may be converted automatically to images forming additional instructional data. Further, the data sources may include three-dimensional scans of special tools or parts. If special tools or parts are not available as CAD models, three-dimensional scans may be generated or created for the user parts from physical available parts using laser scanners or photogrammetric reconstructions.

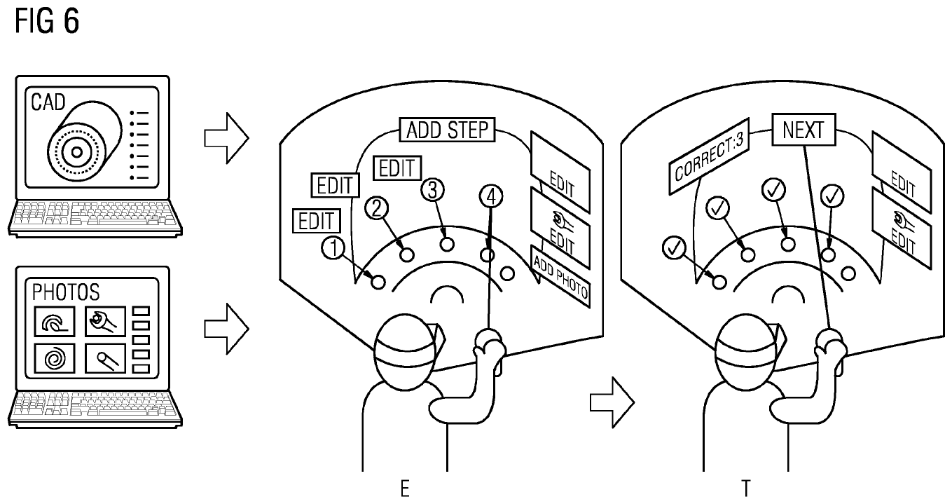

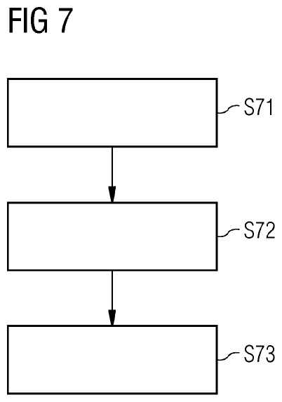

The pre-existing data such as CAD models or photographs, may be imported by the platform into a virtual reality VR training authoring system as also depicted schematically in FIG. 6. Domain expert E may use the VR training authoring system that allows the domain expert E to specify the task procedures that the trainee T is supposed to learn, for example within a virtual reality VR environment. The implemented authoring system may include in a possible embodiment a process of highlighting or selecting different parts of the imported CAD model or the scanned special tools in VR. A further function of the system 1 may be a process configured to select pre-existing images or photographs from a set of images that has been imported by the system 1 from a data source. The system 1 may include a library stored in the database including predefined tools such as wrenches, screwdrivers, hammers etc. as well as ways of selecting them in virtual reality VR. The platform may also provide a function of specifying atomic actions or procedural steps in VR such as removing a specific screw, for example component of an object of interest, with a specific wrench, for example tool. The platform or system 1 further includes a function of creating sequences of actions, for example remove a first screw, then remove a second screw etc. forming part of a VR training session. The platform may further provide a function of arranging images, videos, sketches and or other non-virtual reality (VR) documentation data as supplementary data in helpful positions within the three-dimensional environment optionally associated with a specific procedural step in the sequence of actions forming the training session. The platform may further provide a function of saving a sequence of actions with added supporting photographs as a training and/or guiding sequence.

The trainee T may use the VR training authoring system provided by the platform. The system may allow importing a sequence of actions and arrangements of supporting images or photographs specified by a domain expert E in the authoring system making it available as a virtual reality (VR) training experience to the trainee T. The platform may provide a function of displaying a CAD model, specialized tools, standard tools and supporting photographs on the display unit of a computing device 3 worn by the trainee T in virtual reality VR. The trainee T may perform atomic actions in VR including a component manipulation such as removing a specific screw with a specific wrench. In the training mode, parts, and tools to be used in each atomic action within the atomic action sequence of the training session may be highlighted by the platform. In a possible examination mode, parts or components of a machine M serviced by the trainee T are not highlighted but the trainee T may receive a feedback on whether the procedure step has been performed correctly or not by him.

Accordingly, the platform or system 1 may use a virtual reality (VR) based authoring system and automatic conversion of pre-existing data to create a virtual reality training session for a trainee T. The system 1 allows breaking down a procedure that is supposed to be learned in the training into a sequence of atomic actions using specific parts of a CAD model, virtual tools and may be supported by auxiliary documentation.

FIG. 7 depicts a flowchart of a possible embodiment of a method for generating a virtual reality (VR) training session.

As may be seen in the flowchart of FIG. 7, the method for generating a virtual reality (VR) training session may include several main steps S71, S72, S73.

In a first step S71, a virtual reality (VR) data model of an object of interest is loaded from a database into a virtual reality (VR) authoring system. Such a virtual reality (VR) authoring system is depicted in FIG. 6 in the middle and may be operated by a technical expert, E. The virtual reality (VR) authoring system may be used by the technical expert, E, for generating a virtual reality (VR) training session for a procedure to be performed by at least one trainee on a physical object of interest in a technical environment. In a possible embodiment, the virtual reality (VR) data model of the object of interest may be derived automatically from an available computer-aided design, CAD, model of the physical object of interest as also depicted in FIG. 6 or from a scan pf the object of interest. In a possible embodiment, the computer-aided design, CAD, data model of the physical object of interest may be converted or transformed automatically by a conversion unit of the virtual reality (VR) authoring system. The computer-aided design, CAD, model is a three-dimensional data model. In an embodiment, the virtual reality (VR) model of the object of interest derived from the CAD model is a hierarchical data model representing a hierarchical structure of the physical object of interest including of a plurality of components. The physical object of interest may for instance include a machine including of subsystems where each subsystem has a plurality of interconnected components or machine parts. If special tools or parts are not available as CAD models, three-dimensional scans may be created of them from the actual physical parts using for instance laser scanners or photogrammetric reconstruction. The computer-aided design, CAD, model of the physical object of interest may for instance be stored in the database 5 of the system depicted in FIG. 1 and converted automatically by the processing unit 4A into a virtual reality (VR) model of the object of interest, for example the respective machine.

In a further step S72, atomic procedure steps of the respective procedure are specified by a technical expert E using the training authoring system as also depicted in FIG. 6. The technical expert E performs himself the specified atomic procedural steps in a virtual environment provided by the virtual reality (VR) authoring system on the loaded virtual reality (VR) data model of the object of interest. In a possible embodiment, the technical expert E performs one or more atomic procedural steps in the three-dimensional virtual environment provided by the virtual reality (VR) authoring system using virtual tools loaded also from the database into the virtual reality (VR) authoring system and selected by the technical expert E in the three-dimensional virtual environment for performing the respective atomic procedural steps. In a possible embodiment, the virtual tools used by the technical expert E in the three-dimensional virtual environment to perform the atomic procedural steps are derived also automatically from available computer-aided design, CAD, models of the respective tools. An atomic procedural step performed by the technical expert E in the three-dimensional virtual environment includes a manipulation of at least one displayed virtual component of the object of interest with or without use of a virtual tool. The atomic procedural step may include for instance a moving of the displayed virtual component, a removing of the displayed virtual component, a replacing of the displayed virtual component by another virtual component, connecting a virtual component to a displayed virtual component and/or changing the displayed virtual component.

In a further step S73, the atomic procedural steps performed by the technical expert E in the virtual environment are recorded and the recorded atomic procedural steps are linked to generate automatically the virtual reality (VR) training session stored in the database where it is available for one or more trainees T.

Each recorded atomic procedural step performed by the technical expert E in the three-dimensional virtual reality (VR) environment is enriched with additional or supplementary data selected by the technical expert E in the three-dimensional virtual environment provided by the virtual reality (VR) authoring system. The supplementary data may be imported by the virtual reality (VR) authoring system from different data sources and/or databases selected by the expert E and linked to the recorded atomic procedural step. The supplementary data may include for instance photographs, instruction videos, audio recordings, sketches, slides, text documents and/or instruction manuals.

In a possible embodiment, each recorded atomic procedural step of a procedure is linked to at least one previously recorded procedural step of the same procedure by the technical expert E in the virtual environment by performing a corresponding linking input command In an embodiment, each recorded atomic procedural step of a procedure is linked to at least one previously recorded procedural step of the same procedure automatically depending on supplementary data selected by the technical expert E for the recorded atomic procedural steps.

After the virtual reality (VR) training session has been generated by the technical expert E using the virtual reality (VR) authoring system, the generated virtual reality (VR) training session may be stored in the database 5 of the system and may be made available to one or more trainees T to learn the procedure. The procedure may be for instance a repair or maintenance procedure to be performed on a physical machine of interest. The generated virtual reality (VR) training session stored in the database 5 of the virtual reality (VR) authoring system may be made available in a training operation mode to a virtual reality (VR) device of the trainee T. For instance, a trainee T may wear a virtual reality (VR) headset to have access to the stored training session. The virtual reality (VR) device such as a virtual reality (VR) headset or virtual reality (VR) goggles is configured to display the atomic procedural steps of the stored training session to the respective trainee T who emulates the displayed atomic procedural steps of the training session also in a three-dimensional virtual environment provided by the virtual reality (VR) device of the trainee T as also depicted in FIG. 6. The trainee T may explore the virtual reality (VR) machine model of the object of interest, for example machine, by attempting to take apart different components of the respective machine. In a possible embodiment, a recorded previously generated virtual reality (VR) training session stored in the database 5 may be downloaded by the virtual reality (VR) device of the trainee T to display the virtual reality (VR) session to the trainee T. In an embodiment, a virtual reality (VR) training session generated by the expert E is applied to the trainee T online, for example when the expert E is still operating within the virtual environment. In this embodiment, both the trainee T and the technical expert E are both present in the virtual environment provided by the virtual reality (VR) training system at the same time and may interact with each other. For instance, the technical expert E may guide the trainee T by voice or pointing to parts or components during the virtual reality (VR) training session. The trainee T tries to copy or to emulate the manipulation of the object of interest or component of object of interest during the procedural step according to his abilities.

In a possible embodiment, the virtual reality (VR) authoring system may be switched between different operation modes. In a generation operation mode, the virtual reality (VR) authoring system may be used by a technical expert E to generate a virtual reality (VR) training session for any procedure of interest performed for any physical object of interest. The virtual reality (VR) authoring system may be switched to a training operation mode where a virtual reality (VR) device of the trainee T outputs the atomic procedural steps of the generated training session to the respective trainee T. The virtual reality (VR) training authoring system may also be switched to an examination operation mode. In the examination operation mode, the atomic procedural steps performed by the trainee T in the three-dimensional virtual environment provided by a virtual reality (VR) device are recorded and compared automatically with the recorded atomic procedural steps performed by the domain expert E in the three-dimensional virtual environment of the virtual reality (VR) authoring system. In the examination operation mode, the atomic procedural steps performed by the trainee T and the procedural steps performed by the domain expert E are compared with each other to generate comparison results that are evaluated to provide a feedback to the trainee T indicating to the trainee T whether the trainee T has performed the respective atomic procedural steps correctly or not. In a possible embodiment, the comparison results may be stored and evaluated to analyze a training progress of the trainee T. If the comparison results show that the procedural steps performed by the trainee T are identical or almost identical to the procedural steps performed by the technical expert E, the trainee T may be classified as a qualified trainee having the ability to perform the procedure on a real physical object of interest.

In a possible embodiment, the virtual reality (VR) training session stored in the database of the virtual reality (VR) authoring system may be made available to an augmented reality, AR, guiding device of a qualified trainee T that displays the virtual reality (VR) training session to the trainee T who emulates the displayed atomic procedural steps in the technical environment to perform the procedure on the physical object of interest, for example in the real world.

The procedural steps performed by the technical expert E or the trainee T in the three-dimensional virtual environment during the training operation mode and/or during the examination operation mode of the virtual reality (VR) authoring system may include any kind of manipulation of at least one displayed virtual component of the object of interest with or without use of any kind of virtual tool. The atomic procedural steps may for instance include moving the displayed virtual component, for example moving a component of the displayed virtual component from a first position in the three-dimensional virtual environment to a second position in the three-dimensional virtual environment. Further, the manipulation may include re-moving the displayed virtual component from the virtual environment. A further basic manipulation that may be performed in an atomic procedural step may include the replacement of a displayed virtual component by another virtual component. A further atomic procedural step may include the connection of a virtual component in the three-dimensional virtual environment to a displayed virtual component. Further, an atomic procedural step may include as a manipulation a change of a displayed virtual component, for instance change of a shape and/or material of a displayed virtual component.

The method for generating a virtual reality (VR) training session as depicted in the flowchart of FIG. 7 has the significant advantage that no programming is required to create a specific training session. Once the virtual reality (VR) authoring system has been implemented, the domain expert E may use the virtual reality (VR) training authoring system to create any kinds of individual virtual reality (VR) training sessions without requiring any programming and without requiring any programming skills of the technical expert E.

The virtual reality (VR) training authoring system may be combined with a virtual reality (VR) telepresence system where the domain expert E acting as a trainer and multiple trainees T may virtually appear collocated within the system and where for instance the domain expert E may virtually point at parts of the virtual reality (VR) model of the respective object of interest and may even use voice communication to give guidance in real time during the execution of the virtual reality (VR) training session on a virtual reality (VR) device of a trainee T. The trainee T may also give a feedback during the execution by voice communication to the respective domain expert E

In a possible embodiment, the trainee T performs the training session offline by downloading a prerecorded virtual reality (VR) training session stored in a database 5. In an alternative embodiment, the trainee T may perform the virtual reality (VR) training session online, for example communicating with the domain expert E bidirectional through a communication channel during the execution of the training session. In a possible embodiment, the virtual reality (VR) training system used by the trainee T may be switched between an online operation mode (with bidirectional communication with the domain expert E during the training session) and an offline training operation mode (performing the training session without interaction with the domain expert E). In a possible implementation, bidirectional communication during an online training session may also be performed in a virtual reality (VR) system, for instance a domain expert E may be represented by an Avatar moving in the virtual reality (VR) to give guidance to the trainee T in the virtual reality, VR. In a further possible implementation, the virtual representation of the technical domain expert E and/or the virtual representation of the technical trainee T may move freely in a virtual environment showing for instance a fabrication room of a facility including different physical objects of interest such as fabrication machines.

The virtual reality (VR) training system may be switched between an online training mode (with bidirectional communication with a technical domain expert E) and an offline training mode (without bidirectional communication with a technical domain expert E). In both operation modes, the trainee T may select between a normal training operation mode, an examination operation mode and/or a guiding operation mode where the trainee T emulates the displayed atomic procedural steps in the real technical environment to perform the learned procedure on the physical object of interest or machine. In a possible implementation, the guiding operation mode may only be activated if the trainee T has been authorized as a qualified trainee, for example having demonstrated that he made sufficient training progress to perform the procedure on the physical object of interest, for example the real-world machine in the technical environment. The training progress of any trainee T may be analyzed automatically on the basis of the comparison results generated in the examination operation mode. Further, the comparison results give a feedback to the author of the training session, for example the respective technical expert E whether the generated training session teaches the procedure to the trainees T efficiently. If the training process made by a plurality of trainees T is not sufficient, the domain expert E may amend the generated training session to achieve better training results.

The method for generating a virtual reality (VR) training session for a procedure to be performed on a physical object of interest may be combined with a system for sharing automatically procedural knowledge between domain experts E and trainees T. Observations of the domain expert E by performing an atomic procedural step may be evaluated automatically to generate automatically instructions for the trainee T supplied to the virtual reality (VR) device of the trainee T. In the online operation mode of the virtual reality (VR) authoring system, a virtual assistant may include an autonomous agent configured to perform autonomously a dialog with the domain expert E and/or trainee T while performing the procedure.

In contrast to conventional systems, the platform 1 requires no programming to create a specific training session. Once the VR authoring system has been implemented, and once a basic playback virtual reality (VR) training system has been provided, domain experts E may use the VR training authoring system offered by the platform to create and generate automatically their own VR training sessions. This makes the training faster and more efficient.

The virtual reality (VR) system may be used not only as a VR training system but also as an augmented reality, AR, guidance system. The same data, including sequence of steps, photographs, CAD models and scanned three-dimensional models may be used to play back an appropriate sequence of actions to a trainee T in the field who is in the process of performing a real maintenance task on a real machine M.

In an embodiment of the virtual reality (VR) system, the system may create 360-degree videos of a maintenance workflow. This may be useful as non-interactive training data. For example, a trainee T or worker may review the 360-degree video of a maintenance procedure in the field using a cardboard-style smartphone VR headset, just before actually performing the respective task or procedure.

In an embodiment, the virtual reality (VR) system may be combined with a VR telepresence system where a domain expert E may act as a trainer and multiple trainees T may then virtually appear collocated within the VR training system and the trainer E may virtually point at parts of the CAD model and may use voice communication to give guidance to the trainees T. In an embodiment, trainees T may record their own training sessions for personal review or review by an examiner or expert E. It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for generating a virtual reality training session for a procedure to be performed by a trainee on a virtual reality model of an object of interest in a technical environment, the method comprising:
loading the virtual reality model of the object of interest from a database into a virtual reality authoring system;
specifying atomic procedural steps of a respective procedure by a technical expert and performing the specified atomic procedural steps in a three-dimensional virtual environment provided by the virtual reality authoring system by the technical expert on the loaded virtual reality model of the object of interest; and
recording the atomic procedural steps performed by the technical expert in the three-dimensional virtual environment and linking the recorded atomic procedural steps to generate automatically the virtual reality training session stored in the database for the trainee;
wherein each recorded atomic procedural step performed by the technical expert in the three-dimensional virtual environment is enriched with supplementary data selected by the technical expert in the three-dimensional virtual environment provided by the virtual reality authoring system, and
wherein the supplementary data comprises at least one of photographs, instruction videos, audio recordings, sketches, slides, text documents, or instruction manuals.

2. The method of claim 1 wherein the supplementary data is imported by the virtual reality authoring system from different data sources and linked to the recorded atomic procedural step.

3. The method of claim 1 wherein the technical expert performs one or more atomic procedural steps in the three-dimensional virtual environment provided by the virtual reality authoring system using virtual tools loaded from the database into the virtual reality authoring system and selected by the technical expert in the three-dimensional virtual environment for performing the respective atomic procedural steps.

4. The method of claim 1, wherein each recorded atomic procedural step of a procedure is linked to at least one previously recorded procedural step of the same procedure by the technical expert in the three-dimensional virtual environment or linked depending on the supplementary data selected by the technical expert for the recorded atomic procedural step.

5. The method of claim 1, wherein the generated virtual reality training session stored in the database of the virtual reality authoring system is made available in a training operation mode to a virtual reality device of the trainee configured to display the atomic procedural steps of the generated virtual reality training session to the respective trainee emulating the displayed atomic procedural steps of the generated virtual reality training session in the three-dimensional virtual environment provided by the virtual reality device of the trainee.

6. The method of claim 1, wherein in an examination operation mode, the atomic procedural steps performed by the trainee in the three-dimensional virtual environment provided by its virtual reality device are recorded and compared automatically with the recorded atomic procedural steps performed by the technical expert in the three-dimensional virtual environment of the virtual reality authoring system to generate comparison results and a feedback to the trainee indicating whether the trainee has performed the respective atomic procedural steps correctly or not.

7. The method of claim 6 wherein the comparison results are stored and evaluated to analyze a training progress of the trainee.

8. The method of claim 1, wherein the generated virtual reality training session stored in the database of the virtual reality authoring system is made available to an augmented reality guiding device of the trainee that displays the virtual reality training session to the trainee.

9. The method of claim 1, wherein the virtual reality model of the object of interest is derived automatically from an available computer-aided design model of the object of interest or from a scan of the object of interest.

10. The method of claim 1, wherein the virtual reality model of the object of interest is a hierarchical data model representing a hierarchical structure of the object of interest comprising a plurality of components.

11. The method of claim 1, wherein virtual tools used by the technical expert or the trainee in the three-dimensional virtual environment to perform atomic procedural steps are derived automatically from available computer-aided design models of the respective tools.

12. The method of claim 1, wherein the atomic procedural steps performed by the technical expert or the trainee in the three-dimensional virtual environment comprises a manipulation of at least one displayed virtual component of the object of interest with or without use of a virtual tool, the manipulation comprising at least one of moving the displayed virtual component, removing the displayed virtual component, replacing the displayed virtual component by another virtual component, connecting a virtual component to the displayed virtual component, or changing the displayed virtual component.

13. A virtual reality authoring system for generating a virtual reality training session for a procedure to be performed by a trainee on a virtual reality model of a physical object of interest, the virtual reality authoring system comprising:
a database configured to store the virtual reality model;
a processing unit configured to:
load the virtual reality model of the object of interest from the database;
specify atomic procedural steps of a respective procedure by a technical expert;
record the atomic procedural steps performed by the technical expert in a three-dimensional virtual environment; and
link the recorded atomic procedural steps to generate the virtual reality training session stored in the database for the trainee;
wherein each recorded atomic procedural step performed by the technical expert in the three-dimensional virtual environment is enriched with supplementary data selected by the technical expert in the three-dimensional virtual environment, and
wherein the supplementary data comprises at least one of photographs, instruction videos, audio recordings, sketches, slides, text documents, or instruction manuals.

14. The virutal reality authoring system of claim 13, wherein the supplementary data is imported from different data source and linked to the recorded atomic procedural step.

15. The virutal reality authoring system of claim 13, wherein the technical expert performs one or more atomic procedural steps in the three-dimensional virtual environment provided by the virtual reality authoring system using virtual tools loaded from the database and selected by the technical expert in the three-dimensional virtual environment for performing the respective atomic procedural steps.

16. The virutal reality authoring system of claim 13, wherein each recorded atomic procedural step of a procedure is linked to at least one previously recorded procedural step of the same procedure by the technical expert in the three-dimensional virtual environment or linked depending on the supplementary data selected by the technical expert for the recorded atomic procedural step.

17. The virutal reality authoring system of claim 13, wherein the generated virtual reality training session stored in the database is made available in a training operation mode to a virtual reality device configured to display the atomic procedural steps of the generated virtual reality training session to the trainee by emulating the displayed atomic procedural steps of the generated virtual reality training session in the three-dimensional virtual environment provided by the virtual reality device of the trainee.

18. The virutal reality authoring system of claim 13, wherein in an examination operation mode, the atomic procedural steps performed by the trainee in the three-dimensional virtual environment provided by its virtual reality device are recorded and compared automatically with the recorded atomic procedural steps performed by the technical expert in the three-dimensional virtual environment of the virtual reality authoring system to generate comparison results and a feedback to the trainee indicating whether the trainee has performed the respective atomic procedural steps correctly or not.

19. The virutal reality authoring system of claim 18, wherein the comparison results are stored and evaluated to analyze a training progress of the trainee.
